(19) United States
(12) Patent Application Publication
(10) Pub. No.: US 2002/0106075 A1
(43) Pub. Date: Aug. 8, 2002

(54) Direct electrical connectability of port of splitter unit to connector of interface circuit of switch

(76) Inventors: Thomas Joseph Foss, Rolling Meadows, IL (US); Ronald Alex Nordin, Naperville, IL (US); Paul Raymond Sand, Woodridge, IL (US); Claudis L. Young, Aurora, IL (US)

Correspondence Address: GROSSMAN, PATTI & BRILL, 300 W. WASHINGTON ST. #1200, CHICAGO, IL, 60606-2002, US

(21) Appl. No.: 09/776,388

(22) Filed: Feb. 2, 2001

(51) Int. Cl. H04M 1/00

(52) U.S. Cl. 379/399.01

(57) ABSTRACT

A splitter unit of a system comprises a port that is electrically connectable directly to a connector of an interface circuit of a switch of a central office.

### CROSS-REFERENCE TO RELATED APPLICATIONS

This application contains subject matter which is related to the subject matter of the following applications, which are assigned to the same assignee as this application. The below-listed applications are hereby incorporated herein by reference in their entireties:

“TELECOMMUNICATION EQUIPMENT SUPPORT OF HIGH SPEED DATA SERVICES,” by Nye et al., Ser. No. 08/767,138, filed Dec. 19, 1996.

“A DSL-COMPATIBLE POTS LINE CARD,” by Nordin et al., Ser. No. 09/617,446, filed Jul. 17, 2000.

“COUPLING OF SPLITTER WITH SUBSET OF PLURALITY OF LINES ON ONE-TO-ONE BASIS,” by Corvino et al., Ser. No. ______ , filed concurrently herewith.

### TECHNICAL FIELD

The invention in one embodiment relates generally to telecommunications and more particularly to employment of a splitter at a central office for use with a digital subscriber loop/line (“DSL”).

### BACKGROUND

A splitter in one example comprises a plain old telephone service (“POTS”) splitter. A POTS splitter in one example comprises a low-pass filter and a high-pass filter. The low-pass filter in one example serves to direct analog voice signals to a first line. The high-pass filter in one example serves to direct a DSL signal to a second line. In one example, each line comprises a twisted wire pair.

One implementation employs external splitters. External splitters in one example comprise a separate shelf within a cabinet. As one shortcoming, the separate shelf consumes space within the cabinet.

At a central office, in one example, the telephone company runs lines from the main distribution frame to the splitter shelf. In addition, the telephone company runs lines, for example, of tip and ring cables, from the splitter shelf to a digital subscriber line access multiplexor (“DSLAM”) to provide asymmetric digital subscriber line (“ADSL”) service. Further, the telephone company runs lines from the splitter shelf to an interface circuit, for instance, a POTS interface circuit of a switch, for example, a Class 5 switch, to provide POTS.

At a line that previously provided POTS to a certain subscriber, one technique to update the line to provide asymmetric digital subscriber line service in addition to the POTS, disadvantageously requires identification of a particular POTS interface circuit and a certain tip and ring cable that correspond to the subscriber, in addition to an identification of the routing at the central office of the certain tip and ring cable to the main distribution frame.

Thus, a need exists for enhanced locatability of a splitter at a central office. A further need exists for an enhanced updating of service through employment of a splitter.

### SUMMARY

Pursuant to one embodiment of the invention, shortcomings of the existing art are overcome and additional advantages are provided through the provision of direct electrical connectability of a port of a splitter unit to a connector of an interface circuit of a switch.

The invention in one embodiment encompasses a system. The system includes a splitter unit that comprises a port that is electrically connectable directly to a connector of an interface circuit of a switch of a central office.

Another embodiment of the invention encompasses a method. A splitter unit that comprises a port that is electrically connectable directly to a connector of an interface circuit of a switch of a central office is selected.

These and other features and advantages of one embodiment of the invention will become apparent from the following detailed description, the accompanying drawings, and the claims.

### BRIEF DESCRIPTION OF THE DRAWINGS

FIG. 1 illustrates one example of a system that includes one or more networks, an outside plant, and a central office that includes a main distribution frame, one or more splitter units, a switch with one or more interface circuits, a multiplexor with one or more interface circuits, and one or more lines that comprise one or more tip and ring cables.

FIG. 2 represents illustrative details of one example of a main distribution frame, a plurality of splitter units, a switch with one or more interface circuits, a multiplexor with one or more interface circuits, and a plurality of lines that comprise a plurality of tip and ring cables of the system of FIG. 1.

FIG. 3 represents illustrative details of one example of a tip and ring cable, a splitter unit, and an interface circuit of one example of a switch of the system of FIG. 1.

FIG. 4 depicts illustrative details of one example of a splitter unit of the system of FIG. 1, taken from an exemplary view directed toward a face of the splitter unit that can receive a tip and ring cable of the system of FIG. 1.

FIG. 5 depicts illustrative details of the splitter unit of FIG. 4, taken from an exemplary view of a profile of the splitter unit.

FIG. 6 depicts illustrative details of the splitter unit of FIG. 4, taken from an exemplary view directed toward a face of the splitter unit that can electrically mate with one example of an interface circuit of the switch of the system of FIG. 1.

### DETAILED DESCRIPTION

In one embodiment of the invention, a port of a splitter unit is electrically connectable directly to a connector of an interface circuit of a switch. A detailed discussion of one exemplary embodiment of the invention is presented herein, for illustrative purposes.

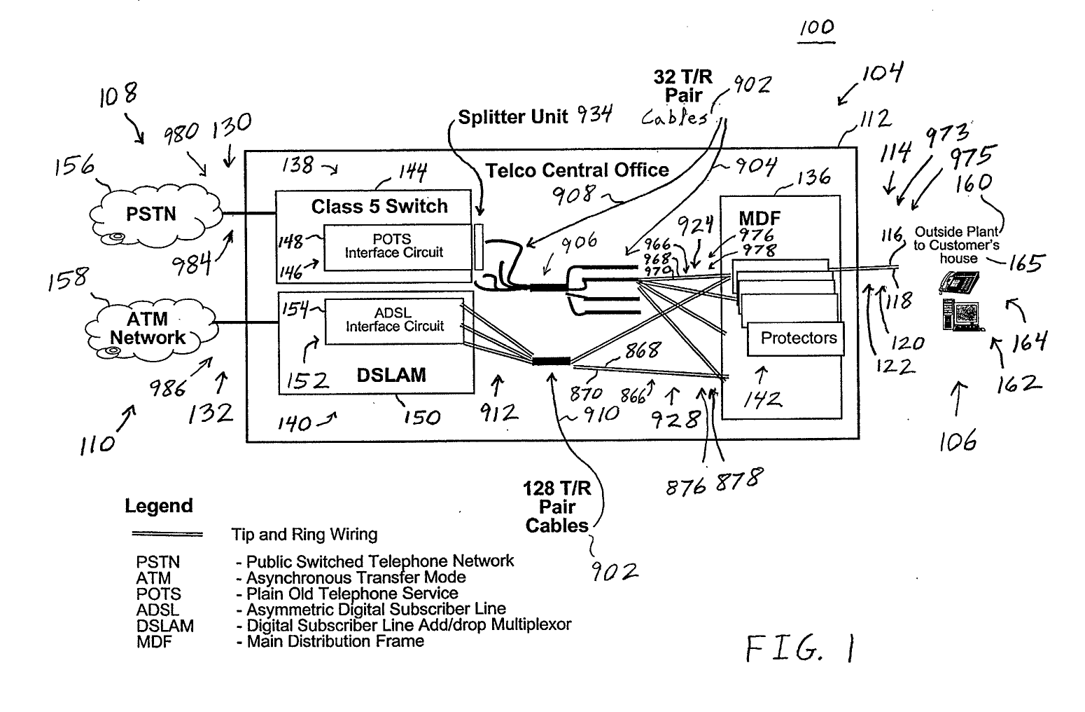

Turning to FIG. 1, system 100, in one example, includes a plurality of components such as computer hardware components. A number of such components can be combined or divided in one example of system 100.

Referring again to FIG. 1, system 100 in one example comprises one or more components, for example, components 104 and 106, networks 108 and 110, a plurality of instances of line 114, and facilities 130 and 132.

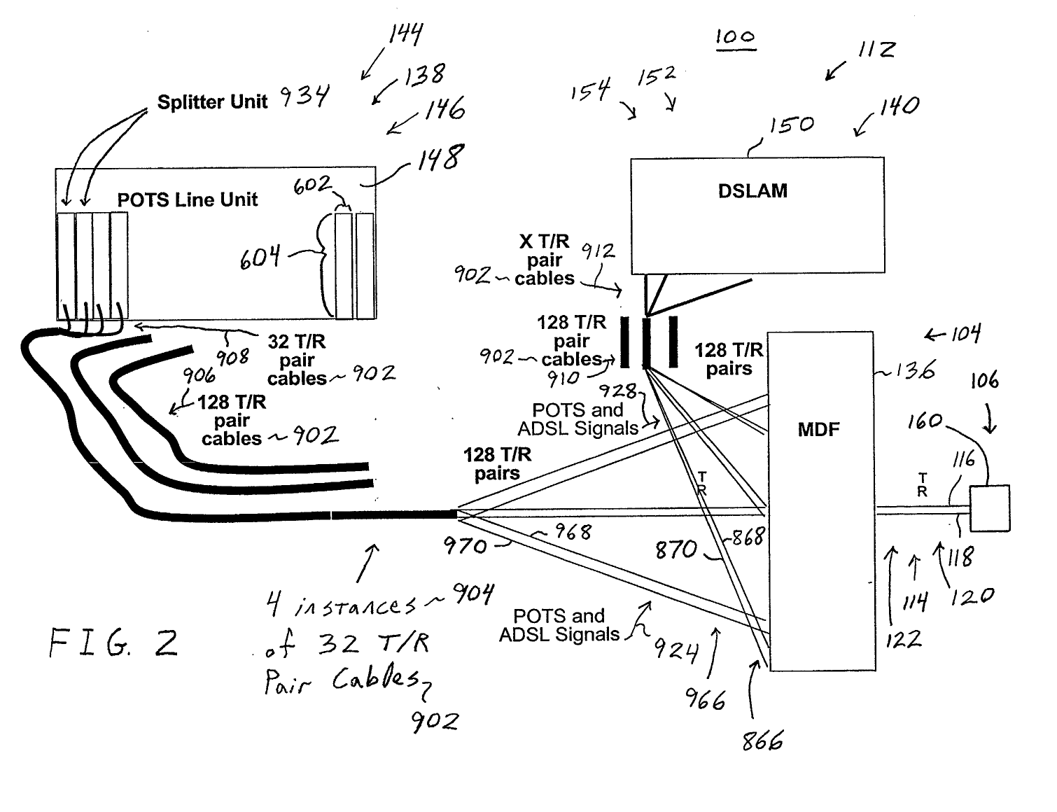

Now referring to FIGS. 1-2, line 114 in one example serves to connect and/or couple one or more components of system 100 with one or more other components of system 100. In one example, line 114 comprises wires 116 and 118. For example, wires 116 and 118 each comprise solid wire such as twenty-two to twenty-six gauge solid wire. Wire 116 in one example comprises a tip (“T”) wire. Wire 118 in one example comprises a ring (“R”) wire. Wires 116 and 118 in one example comprise twisted wire pair 120, as will be appreciated by those skilled in the art. Exemplary instances of line 114 comprise lines 122, 924, and 928. A plurality of instances of line 114 in one example comprise cable 902. Exemplary instances of cable 902 comprise tip and ring (“T/R”) cables 904, 906, 908, 910, and 912.

Referring to FIG. 1, line 122 in one example serves to couple component 104 with component 106. Exemplary instances of facilities 130 and 132 comprise interoffice facilities, for example, E3, DS3, E1, DS1, STM-1, and OC3, as will be understood by those skilled in the art. Facility 130 in one example serves to couple component 104 with network 108. Facility 132 in one example serves to couple component 104 with network 110.

Referring still to FIG. 1, component 104 in one example comprises central office (“CO”) 112. Central office 112 in one example comprises a local telephone company switching center and/or a telecommunications central office. For example, central office 112 comprises an end office, for instance, a class 5 office. In one example, central office 112 connects directly to component 106. In a further example, central office 112 provides customer services such as call waiting and call forwarding. In a still further example, central office 112 performs billing, as will be appreciated by those skilled in the art.

Again referring to FIG. 1, central office 112 in one example comprises one or more instances of splitter unit 934, main distribution frame (“MDF”) 136, switch 138, and multiplexor 140. Line 122 in one example serves to couple component 106 with main distribution frame 136. One or more instances of line 924 and one or more instances of tip and ring cables 904, 906, and 908 in one example serve to couple main distribution frame 136 with one or more instances of splitter unit 934. In a further example, one or more instances of line 928 and one or more instances of tip and ring cables 910 and 912 serve to couple main distribution frame 136 with multiplexor 140. Facility 130 in one example serves to couple switch 138 with network 108. Facility 132 in one example serves to couple multiplexor 140 with network 110.

Still referring to FIG. 1, splitter unit 934 in one example is advantageously compatible with standard and/or known wiring for POTS, and desirably allows an addition of DSL service.

Further referring to FIG. 1, splitter unit 934 in one example advantageously serves to update one or more lines of central office 112 from a POTS line to a POTS and asymmetric digital subscriber service line (e.g., one or more of line 924 and cables 904, 906, and 908). For example, splitter unit 934 advantageously prepares one or more lines central office 112 asymmetric digital subscriber service, as an addition to for POTS. Advantageously, splitter unit 934 in one example is connectable with switch 138 and one or more instances of cable 908 without employment of a splitter shelf.

Referring again to FIG. 1, main distribution frame 136 in one example comprises a connecting unit between instances of line 114 that relative to central office 112 are external, and instances of line 114 that relative to central office 112 are internal. For example, main distribution frame 136 comprises a connecting unit between an instance of line 122 that is external relative to central office 112, and an instance of line 924 that is internal relative to central office 112.

Referring further to FIG. 1, in one example, main distribution frame 136 comprises one or more instances of protector 142. Protector 142 in one example serves to protect central office 112 from possible damage that otherwise could result, for example, from foreign over-voltage and/or over-current introduced in outside plant 160 on one or more instances of line 114. Main distribution frame 136 in one example comprises a plurality of instances of protector 142. In one example, each instance of protector 142 of the plurality of instances of protector 142 serves to couple corresponding instances of lines 122, 924, and 928. For example, main distribution frame 136 comprises a first instance of protector 142 that serves to couple a first instance of line 122 with first instances of lines 924 and 928, and a second instance of protector 142 that serves to couple a second instance of line 122 with second instances of lines 924 and 928. In a further example, an instance of protector 142 of main distribution frame 136 receives a signal from an instance of line 122 as input, and transmits signals (e.g., of substantially equal value and/or magnitude) to instances of lines 924 and 928 as output.

Now referring to FIGS. 1-2, switch 138 in one example comprises Class 5 switch 144. For example, switch 138 comprises circuit 146. Circuit 146 in one example comprises POTS interface circuit 148. POTS interface circuit 148 in one example comprises physical dimensions 602 and 604. Physical dimension 602 in one example comprises a width of POTS interface circuit 148. Physical dimension 604 in one example comprises a height of POTS interface circuit 148.

Referring to FIG. 1, multiplexor 140 in one example comprises a digital subscriber line multiplexor, for example, digital subscriber line add/drop multiplexor (“DSLAM”) 150. digital subscriber line add/drop multiplexor 150 in one example comprises circuit 152. Circuit 152 in one example comprises asymmetric digital subscriber line (“ADSL”) interface circuit 154.

Again referring to FIG. 1, network 108 in one example comprises public switched telephone network (“PSTN”) 156. Public switched telephone network 156 in one example comprises the worldwide voice telephone network, as will be understood by those skilled in the art.

Referring further to FIG. 1, network 110 in one example comprises asynchronous transfer mode (“ATM”) network 158. Asynchronous transfer mode network 158 in one example supports realtime voice, video, and data.

Again referring to FIG. 1, component 106 in one example comprises outside plant 160. Outside plant 160 in one example comprises a feeder and distribution system, for example, to a number of instances of home 162 and/or office 164 of one or more instances of customer 165 of central office 112.

Referring to FIGS. 1-2, an instance of line 924 in one example comprises POTS and asymmetric digital subscriber line 966. POTS and asymmetric digital subscriber line 966 in one example comprises wires 968 and 970. Wire 968 in one example comprises a tip wire. Wire 970 in one example comprises a ring wire.

Again referring to FIGS. 1-2, an instance of line 928 in one example comprises POTS and asymmetric digital subscriber line 866. POTS and asymmetric digital subscriber line 866 in one example comprises wires 868 and 870. Wire 868 in one example comprises a tip wire. Wire 870 in one example comprises a ring wire.

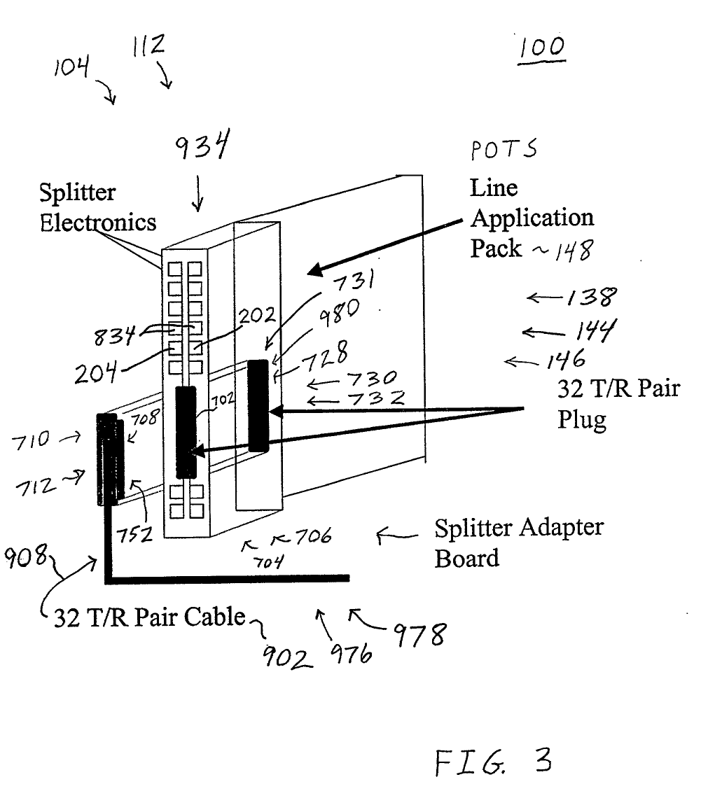

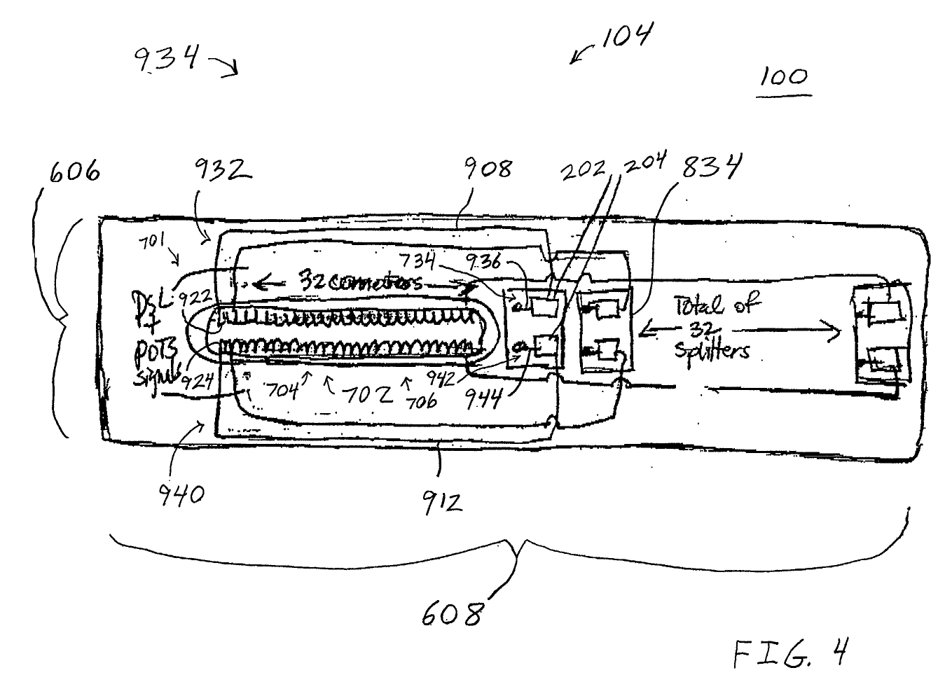

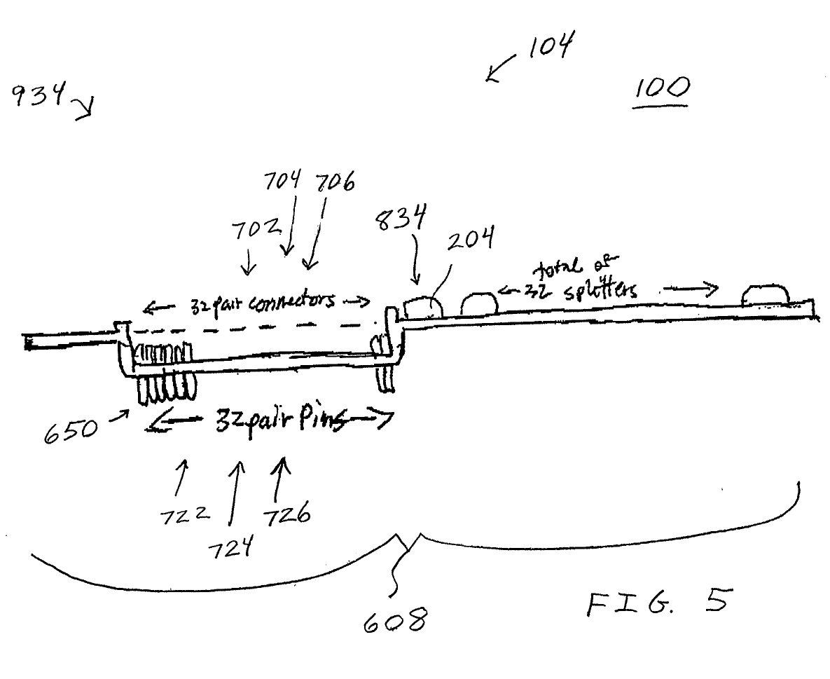

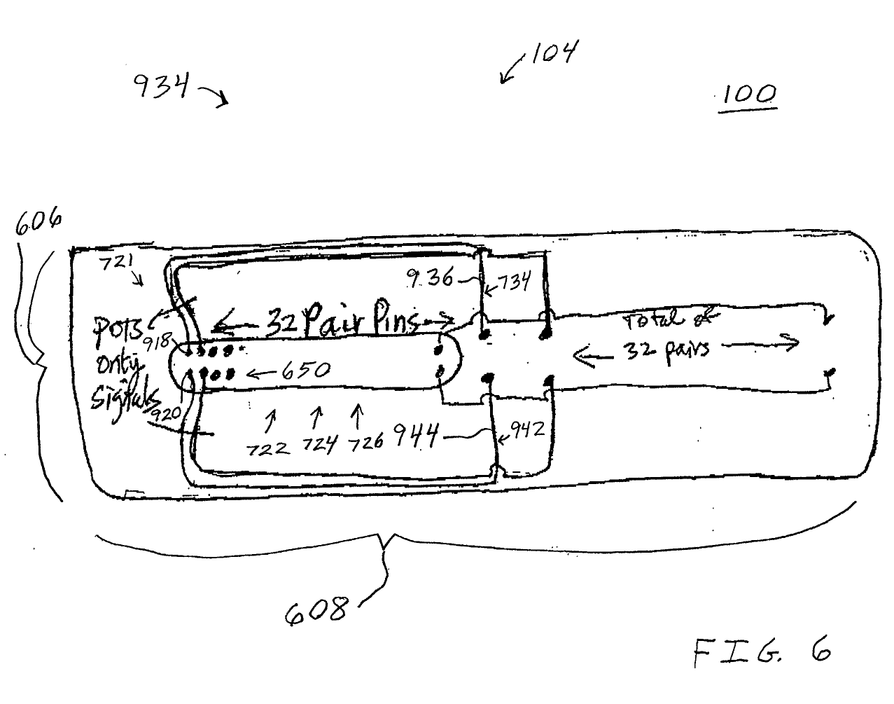

Turning to FIGS. 3-6, splitter unit 934 in one example comprises one or more instances of splitter 834. For example, splitter unit 934 comprises a plurality of instances of splitter 834. In one example, splitter unit 934 comprises thirty-two instances of splitter 834. For example, the number of instances of splitter 834 equals the number of instances of subport 731 of connector 728 of circuit 146 of switch 138, as described herein.

Again referring to FIGS. 3-6, splitter 834 in one example comprises a splitter component. For example, splitter 834 comprises filters 202 and 204, wires 908, 912, 936, and 944, and connectors 918, 920, 922, and 924. Filters 202 and 204 in one example each comprise a low-pass filter. For example, filters 202 and 204 each comprise a 4 kHz low-pass filter.

Referring to FIGS. 2 and 4-6, splitter unit 934 in one example comprises physical dimensions 606 and 608. Physical dimension 606 in one example comprises a width of splitter unit 934. Physical dimension 608 in one example comprises a height of splitter unit 934. Physical dimension 606 of splitter unit 934 in one example (e.g., substantially) matches physical dimension 602 of POTS interface circuit 148. For example, physical dimension 606 of splitter unit 934 (e.g., substantially) equals physical dimension 602 of POTS interface circuit 148. Physical dimension 608 of splitter unit 934 in one example (e.g., substantially) matches physical dimension 604 of POTS interface circuit 148. For example, physical dimension 608 of splitter unit 934 (e.g., substantially) equals physical dimension 604 of POTS interface circuit 148.

Referring to FIGS. 3-6, wire 908 in one example serves to couple connector 922 with filter 202. For example, connector 922 comprises subport 701. Subport 701 in one example comprises one or more of a plug and a receptacle. In one example, a plurality of instances of connector 922 comprise connector 702. Connector 702 in one example comprises port 704. For example, connector 702 comprises female interface 706. In one example, system 100 employs connector 702 to couple splitter unit 934 with connector 708 of cable 908. Connector 708 in one example comprises port 710. Port 710 in one example comprises a plurality of instances of subport 750. For example, subport 750 comprises pin 752, for instance, a protrusion. In a further example, port 710 comprises male interface 712. For example, a plurality of instances of subport 750 comprise male interface 712.

Referring still to FIGS. 3-6, in one example, port 710 of cable 908 comprises thirty-two instances of subport 750. For example, the number of instances of subport 701 of splitter unit 934 equals the number of instances of subport 750 of cable 908. In a further example, each instance of subport 701 of splitter unit 934 is electrically connectable directly to a respective instance of subport 750 of cable 908.

Referring again to FIGS. 3-6, wire 936 in one example serves to couple filter 202 with connector 918. Connectors 918 and 920 of splitter unit 934 in one example comprise instances of subport 650 of port 724. For example, subport 650 comprises pin 721, for instance, a protrusion. In one example, a plurality of instances of subport 650 comprise port 724. Port 724 in one example comprises male interface 726. In a farther example, port 724 comprises connector 722. In one example, system 100 employs connector 722 to couple splitter unit 934 with connector 728 of switch 138. For example, system 100 employs connector 722 to couple splitter unit 934 with connector 728 of circuit 146 of switch 138.

Still referring to FIGS. 3-6, connector 728 of circuit 146 of switch 138 in one example comprises port 730. Port 730 in one example comprises one or more instances of subport 731. Subport 731 in one example comprises one or more of a connection point, receptacle, and plug. For example, port 730 comprises female interface 732. Female interface 732 in one example comprises a plurality of instances of subport 731. In one example, port 730 of circuit 146 of switch 138 comprises thirty-two instances of subport 731. For example, the number of instances of subport 650 of splitter unit 934 equals the number of instances of subport 731 of connector 728 of circuit 146 of switch 138. In a further example, each instance of subport 650 of splitter unit 934 is electrically connectable directly to a respective instance of subport 731 of connector 728 of circuit 146 of switch 138.

Referring to FIG. 1, outside plant 160 in one example sends signal 973 across line 122 to central office 112. For example, outside plant 160 sends signal 973 across line 122 to main distribution frame 136. Signal 973 in one example comprises POTS and asymmetric digital subscriber line signal 975. Main distribution frame 136 in one example employs POTS and asymmetric digital subscriber line signal 975 to obtain signals 976 and 876. Signal 976 in one example comprises POTS and asymmetric digital subscriber line signal 978. Signal 876 in one example comprises POTS and asymmetric digital subscriber line signal 878.

Still referring to FIG. 1, main distribution frame 136 in one example sends POTS and asymmetric digital subscriber line signal 978 across line 924 and cables 904, 906, and 908 to splitter unit 934. Splitter unit 934 in one example employs POTS and asymmetric digital subscriber line signal 978 to obtain POTS signal 980.

Referring again to FIG. 1, in a further example, main distribution frame 136 sends POTS and asymmetric digital subscriber line signal 878 across line 928 to multiplexor 140. For example, main distribution frame 136 sends POTS and asymmetric digital subscriber line signal 878 across line 128 to asymmetric digital subscriber line interface circuit 154. Asymmetric digital subscriber line interface circuit 154 in one example employs POTS and asymmetric digital subscriber line signal 878 to obtain and send asynchronous transfer mode signal 986 across facility 132 to asynchronous transfer mode network 158.

Again referring to FIGS. 1-6, connector 922 of splitter unit 934 in one example employs POTS and asymmetric digital subscriber line signal 978 from main distribution frame 136 to obtain and send POTS and asymmetric digital subscriber line signal 932 across wire 908 to filter 202. Filter 202 in one example employs POTS and asymmetric digital subscriber line signal 932 to obtain and send POTS signal 734 across wire 936 to connector 918.

Referring further to FIGS. 1-6, connector 924 of splitter unit 934 in one example employs POTS and asymmetric digital subscriber line signal 978 to obtain and send POTS and asymmetric digital subscriber line signal 940 across wire 912 to filter 204. Filter 204 in one example employs POTS and asymmetric digital subscriber line signal 940 to obtain and send POTS signal 942 across wire 944 to connector 920.

Referring still to FIGS. 1-6, connectors 918 and 920 of splitter unit 934 in one example employ signals 734 and 942 to obtain and send POTS signal 980 to connector 728 of switch 138. For example, splitter unit 934 sends POTS signal 980 connector 728 to POTS interface circuit 148. POTS interface circuit 148 in one example employs POTS signal 980 to obtain and send POTS signal 984 across facility 130 to public switched telephone network 156.

The flow diagrams depicted herein are just exemplary. There may be many variations to these diagrams or the steps or operations described therein without departing from the spirit of the invention. For instance, the steps may be performed in a differing order, or steps may be added, deleted, or modified.

Although exemplary embodiments of the invention have been depicted and described in detail herein, it will be apparent to those skilled in the relevant art that various modifications, additions, substitutions, and the like can be made without departing from the spirit of the invention and these are therefore considered to be within the scope of the invention as defined in the following claims.

What is claimed is:

1. A system, comprising:
a splitter unit that comprises a port that is electrically connectable directly to a connector of an interface circuit of a switch of a central office.

2. The system of claim 1, wherein the connector of the interface circuit comprises a plural number of connection points; and
wherein the splitter unit comprises a plural number of splitter components equal in number and electrically connectable to the plural number of connection points of the interface circuit.

3. The system of claim 2, wherein the port of the splitter unit is employable to electrically connect directly each of the plural number of splitter components with a respective one of the plural number of connection points of the interface circuit.

4. The system of claim 1, wherein the connector of the interface circuit comprises a plural number of connection points; and
wherein the port comprises a plural number of subports equal in number and electrically connectable directly to the plural number of connection points of the interface circuit.

5. The system of claim 1, wherein the port comprises a port that is electrically connectable directly to a connector of a plain old telephone service interface circuit of the switch of the central office.

6. The system of claim 1, wherein the port comprises a male interface that is electrically connectable directly to a female interface that comprises the connector of the interface circuit of the switch of the central office.

7. The system of claim 1, wherein the port comprises a first port; and
wherein the splitter unit comprises a second port that is electrically connectable directly to a connector of a tip and ring cable of the central office, wherein the second port is electrically connected to the first port.

8. The system of claim 7, wherein the step of selecting the splitter unit to comprise the second port that is electrically connectable directly to the connector of the tip and ring cable of the central office comprises the step of:
selecting the second port to comprise a female interface that is electrically connectable directly to a male interface that comprises the connector of the tip and ring cable of the central office.

9. The system of claim 1, wherein the splitter unit comprises a first splitter unit, wherein the interface circuit comprises a first interface circuit, and further comprising:
a second splitter unit that comprises a port that is electrically connectable directly to a connector of a second interface circuit of the switch of the central office.

10. The system of claim 1, wherein the splitter unit is employable to prepare one or more lines of the central office for asymmetric digital subscriber line service.

11. The system of claim 1, wherein the interface circuit comprises a physical dimension; and
wherein the splitter unit comprises a physical dimension that substantially matches the physical dimension of the interface circuit.

12. The system of claim 11, wherein the physical dimension of the interface circuit comprises a first physical dimension of the interface circuit, wherein the interface circuit comprises a second physical dimension; and
wherein the splitter unit comprises a second physical dimension that substantially matches the second physical dimension of the interface circuit.

13. A method, comprising the step of:
selecting a splitter unit that comprises a port that is electrically connectable directly to a connector of an interface circuit of a switch of a central office.

14. The method of claim 13, wherein the connector of the interface circuit comprises a plural number of connection points, wherein the step of selecting the splitter unit that comprises the port that is electrically connectable directly to the connector of the interface circuit of the switch of the central office comprises the step of:
selecting the splitter unit to comprise a plural number of splitter components equal in number and electrically connectable to the plural number of connection points of the interface circuit.

15. The method of claim 14, wherein the step of selecting the splitter unit that comprises the port that is electrically connectable directly to the connector of the interface circuit of the switch of the central office comprises the step of:
employing the port of the splitter unit to electrically connect directly each of the plural number of splitter components with a respective one of the plural number of connection points of the interface circuit.

16. The method of claim 13, wherein the connector of the interface circuit comprises a plural number of connection points, wherein the step of selecting the splitter unit that comprises the port that is electrically connectable directly to the connector of the interface circuit of the switch of the central office comprises the step of:
selecting the port to comprise a plural number of subports equal in number and electrically connectable directly to the plural number of connection points of the interface circuit.

17. The method of claim 13, wherein the step of selecting the splitter unit that comprises the port that is electrically connectable directly to the connector of the interface circuit of the switch of the central office comprises the step of:
selecting the port to comprise a port that is electrically connectable directly to a connector of a plain old telephone service interface circuit of the switch of the central office.

18. The method of claim 13, wherein the step of selecting the splitter unit that comprises the port that is electrically connectable directly to the connector of the interface circuit of the switch of the central office comprises the step of:
selecting the port to comprise a male interface that is electrically connectable directly to a female interface that comprises the connector of the interface circuit of the switch of the central office.

19. The method of claim 13, wherein the port comprises a first port, and further comprising the step of:
selecting the splitter unit to comprise a second port that is electrically connectable directly to a connector of a tip and ring cable of the central office, wherein the second port is electrically connected to the first port.

20. The method of claim 19, wherein the step of selecting the splitter unit to comprise the second port that is electrically connectable directly to the connector of the tip and ring cable of the central office comprises the step of:
selecting the second port to comprise a female interface that is electrically connectable directly to a male interface that comprises the connector of the tip and ring cable of the central office.

21. The method of claim 13, wherein the splitter unit comprises a first splitter unit, wherein the interface circuit comprises a first interface circuit, and further comprising the step of:
selecting a second splitter unit that comprises a port that is electrically connectable directly to a connector of a second interface circuit of the switch of the central office.

22. The method of claim 13, wherein the step of selecting the splitter unit that comprises the port that is electrically connectable directly to the connector of the interface circuit of the switch of the central office comprises the step of:
employing the splitter unit to prepare one or more lines of the central office for asymmetric digital subscriber line service.

23. The method of claim 13, wherein the interface circuit comprises a physical dimension, wherein the step of selecting the splitter unit that comprises the port that is electrically connectable directly to the connector of the interface circuit of the switch of the central office comprises the step of:
selecting the splitter unit to comprise a physical dimension that substantially matches the physical dimension of the interface circuit.

24. The method of claim 23, wherein the physical dimension of the interface circuit comprises a first physical dimension of the interface circuit, wherein the interface circuit comprises a second physical dimension, wherein the step of selecting the splitter unit that comprises the port that is electrically connectable directly to the connector of the interface circuit of the switch of the central office comprises the step of:
selecting the splitter unit to comprise a second physical dimension that substantially matches the second physical dimension of the interface circuit.
